(19) United States
(12) Patent Application Publication
(10) Pub. No.: US 2019/0174774 A1
(43) Pub. Date: Jun. 13, 2019

(54) PROCESS FOR CUSTOMISING THE FLAVOUR OF BREADS OR PASTRIES

(71) Applicant: LESAFFRE ET COMPAGNIE, Paris (FR)

(72) Inventors: Emilie Bryckaert, Marcq-En-Baroeul (FR); Florence Delchambre, Quesnoy-Sur-Deule (FR); Camille Dupuy-Cornuaille, Marcq-En-Baroeul (FR); Stephane Meillier, Roncq (FR)

(21) Appl. No.: 16/088,330

(22) PCT Filed: Mar. 30, 2017
(86) PCT No.: PCT/FR2017/050731

§ 371 Date: Sep. 25, 2018

(30) Foreign Application Priority Data
Mar. 31, 2016 (FR) 16 52812

(51) Int. Cl. A21D 13/22

(52) U.S. Cl. CPC A21D 13/22

(57) ABSTRACT

The present invention relates to a process for customising the flavour of bread or pastries, in which the following is applied to the surface of the shaped dough or to the crust of the bread or the pastry product, before final baking: a liquid flavouring composition, in which the concentration of flavour-providing ingredient is from 5 to 50% by weight of the liquid composition, or—a pulverulent flavouring composition comprising 1 to 30% of flavour-providing ingredient and 70 to 99% of a. support selected from the group comprising flour, semolina, seeds such as sesame seeds, poppy seeds, cereals such as oat flakes, and mixtures thereof.

The present invention relates to a process for customizing the flavor of breads and/or pastries.

Consumers have increasingly specific demands as regards the flavor of bread and pastry. Bakers must thus be capable of offering their customers a wide variety of tastes or flavors for their breads and pastries. This requirement as regards taste is accompanied by an even greater expectation as regards the nature of the products used. Nowadays, it is mainly natural products for which consumers are keenly motivated.

Solutions currently exist for customizing the taste of bread/pastry, which consist mainly in directly adding to the dough mixer, during the addition of the various ingredients, before kneading, various aromatic products, for example leavens, malts, yeast extracts, natural or synthetic flavorings, dried fruit, seeds, etc. These ingredients added to the dough before kneading make it possible to obtain varied aromatic profiles that are quite perceptible to the consumer. However, for each desired taste, a specific production must be implemented.

Another technical solution concerns the incorporation of aromatic products at the end of kneading. This method makes it possible, starting with a single dough recipe and after dividing said dough among smaller dough mixers, to customize it into various recipes. Time saving is attributed to this technique. However, the overkneading required for the mixing of the aromatic product with the dough may give rise to rheology problems such as tack.

Furthermore, these two methods usually require large doses of pure aromatic products, for example ranging up to 15% (relative to the weight of the flour), especially for leavens. Such doses are necessary in order to significantly typify the crumb of the bakery/pastry products.

Finally, and more particularly as regards pastry, a wide range of product flavorings concern synthetic flavorings, for example vanilla, which require specific labeling and are increasingly less in favor with consumers in search of natural products. Natural flavorings are thus an alternative to this obstacle, but their price makes them difficult to use.

There is thus a real need for a process for customizing the taste of breads and/or pastries, the cost of which remains economically competitive, which maintains all the qualities of the product and allows a wide range of flavors and intensities while at the same time being easy to implement.

The present inventors have found that it is possible to customize the taste of breads and/or pastries by modifying the taste of the crust. Specifically, the taste of the crust has a significant impact on the overall perception, i.e. both on the crumb and on the crust of the bread/pastry and its appreciation by the consumer.

Thus, one subject of the present invention is a process for customizing the taste of breads or pastries, in which a flavoring composition comprising a flavoring ingredient is applied to the surface of the shaped dough ball or to the prebaked crust of breads/pastry, in both cases before final baking.

The flavoring composition may be a liquid composition or a solid composition in powder form.

According to one embodiment of the process of the invention, the flavoring ingredient is placed in a liquid medium, which may be water or a browning preparation.

According to another embodiment of the process of the invention, the flavoring ingredient is mixed, before its application, with a support chosen from the group comprising flour, semolina, seeds such as sesame seeds, poppy seeds, cereals such as oat flakes, and mixtures thereof.

The flavoring composition in liquid form is prepared by mixing at least one flavoring ingredient in water, in a proportion of from 5% to 50% of flavoring product in 95% to 50% of water, said flavoring ingredient being chosen from malt, malt extract, yeast derivatives, leavens or a mixture thereof.

In the case of browning, between 1% and 15% of the liquids mentioned above (i.e. mixture of the flavoring in water) are incorporated into 99% to 85% of browning.

In the present patent application, the percentages are mass percentages.

The flavoring composition in pulverulent form is prepared by mixing at least one flavoring ingredient with a support chosen from the group comprising flour, semolina, seeds such as sesame seeds, poppy seeds, cereals such as oat flakes, and mixtures thereof.

Such a pulverulent flavoring composition comprises from 1% to 30% of flavoring ingredient, said ingredient being chosen from malt, malt extract, yeast derivatives, leavens and mixtures thereof, and from 70% to 99% of support.

A subject of the present invention is thus more particularly a process for customizing the taste of bread or pastry, in which the following are applied to the surface of the shaped dough ball or to the crust of the bread or pastry, before final baking:

a liquid flavoring composition in which the concentration of flavoring ingredient is from 5% to 50% by weight of the liquid composition, or
a pulverulent flavoring composition comprising 1% to 30% of flavoring ingredient and 70% to 99% of a support chosen from the group comprising flour, semolina, seeds such as sesame seeds, poppy seeds, cereals such as oat flakes, and mixtures thereof.

According to one embodiment of the process of the invention, in the pulverulent aromatic composition, the flavoring ingredient is present in a content ranging from 1% to 15% and the support is present in an amount ranging from 85% to 99%.

According to another embodiment of the process of the invention, in the pulverulent aromatic composition, the flavoring ingredient is present in a content ranging from 15% to 30% and the support is present in an amount ranging from 70% to 85%.

The flavoring composition used in the process according to the invention is a composition comprising as flavoring or taste ingredient: malt, a malt extract, a yeast derivative, i.e. a yeast extract or a deactivated yeast, a dry or liquid leaven or any mixture of these ingredients.

In the present invention, the term “bread” means any product obtained by baking a dough obtained by kneading a composition comprising at least flour, water and salt and raised using a raising agent, in particular yeast.

The term “malt” means any germinated cereal, especially barley, wheats including bread wheat and other wheat varieties, rye, sorghum, which is baked in order to release all its flavors.

The term “malt extract” means a broth formed from malted flour mixed with water and which has undergone an enzymatic hydrolysis process. The term “yeast extract” means the soluble part of the yeast which is obtained after autolysis and/or plasmolysis of the yeast and separation of the soluble part from the insoluble part. The yeast extracts used in the process of the invention are extracts of Saccharomyces cerevisiae, Saccharomyces chevalieri, Pichia jadinii (Torula), Saccharomyces Boulardii.

The term “leaven” means a breadmaking ferment derived from a mixture of flour and water in which is exerted the metabolic activity of a heterogeneous population of lactic acid bacteria and yeasts, either by spontaneous fermentation (“natural” leaven) or by fermentation initiated with a starter culture, with or without refreshing. This term also includes leavens produced industrially such as active live leaven or devitalized leaven, and also leaven starter.

The yeast derivatives make it possible to give the crust cracker, cheese, bacon, broth and/or grilled notes. The leavens make it possible to give the crust acetic, lactic, cracker and/or grilled notes. The malts and malt extracts make it possible to give coffee, cocoa, walnut, hazelnut, leaven, honey, malted and/or smoky notes.

According to one embodiment of the process of the invention, the flavoring ingredient is placed in a liquid medium or in browning, preferably water, or is mixed with a support as defined above.

According to a particular embodiment, a flavoring composition in liquid form is applied to a shaped raw dough ball, to the crust of a prebaked bread or pastry or to the crust of a frozen prebaked bread or pastry.

As regards pastry, the flavoring composition may also be provided via the browning, in which case the flavoring ingredient or the aqueous solution comprising it is introduced directly into the browning preparation.

The application of the liquid flavoring solution to the bread/pastry may be performed via any known means and especially by spraying.

According to an advantageous embodiment, the application is performed by spraying. Spraying makes it possible to distribute the aromatic composition uniformly over the entire surface of the shaped dough ball, or over the entire surface of the crust on emerging from prebaking, before baking. It also makes it possible to minimize the amount of liquid composition applied.

The spraying process thus makes it possible to deposit from 4 to 40 mg of liquid flavoring composition per cm² of dough surface before or after prebaking, preferably from 10 to 22 mg of liquid flavoring composition per cm² of sprayed dough surface, depending on the desired flavor input.

According to another particular embodiment, the composition is pulverulent and is applied by dusting.

Dusting is performed on the shaped dough ball before placing it in the oven or on the crust of the bread or pastry before placing it in the oven.

The dusting process makes it possible to deposit, according to one embodiment of the invention, from 4 to 100 mg, preferably from 17 to 48 mg, of aromatic composition onto each cm² of dough ball or of bread or pastry crust.

According to one embodiment of the invention, the dusting process makes it possible to deposit from 4 to 50 mg, preferably from 17 to 26 mg, of aromatic composition onto each cm² of dough ball or of bread or pastry crust.

According to one embodiment of the invention, the dusting process makes it possible to deposit from 50 to 100 mg, preferably from 26 to 48 mg, of aromatic composition onto each cm² of dough ball or of bread or pastry crust.

When the composition is in pulverulent form, the mixing of the flavoring ingredient with the support may be performed via various techniques.

Among these techniques, mention may be made of:
simple physical mixing of the support and of the flavoring agent,
coating-drying incorporating a step of spraying an aqueous solution comprising the flavoring agent around the support, followed by a step of drying the coated support thus obtained. According to a preferred embodiment, the spraying and drying are performed simultaneously via a coating-drying technique in a fluidized bed.

Advantageously according to the invention, the amount of ingredient required for flavoring via these spraying or dusting processes is between 2 and 10 times less than in the case of flavoring by incorporating this ingredient in the dough mixer.

The process according to the invention may be applied to any type of breadmaking, at the artisanal or industrial scale.

The baking step makes it possible, via the Maillard reactions, to generate or specifically reinforce certain flavors provided by the flavoring solutions proposed. Specifically, for the same product with aromatic power such as leaven, the flavors of the bread obtained by incorporation in the dough mixer or spraying on the crust are different.

The process may be used either with direct processes for manufacturing bread/pastry or via processes including a prebaking step.

According to a particular embodiment, known as the “direct process”, bread or pastry is prepared according to the following successive steps:

1. Kneading

2. Division

3. Shaping

4. Fermentation

5. Baking,

the flavoring composition being applied just before the baking step 5.

According to another particular embodiment, known as the “process including prebaking”, bread or pastry is prepared according to the following successive steps:

1′. Kneading

2′. Division

3′. Shaping

4′. Fermentation

5′. Prebaking

6′. Baking,

the flavoring composition being applied either just before the prebaking step 5′ or just before the baking step 6′.

A subject of the invention is also a process for customizing the taste of breads or pastries in which a flavoring composition is applied to the crust of baked breads or pastries, in both cases immediately after final baking.

The flavoring composition is applied immediately after final baking, while the breads and/or pastries are still very hot.

The liquid flavoring composition may be applied, for example, by spraying onto a baked bread/pastry as soon as it is taken from the oven, which allows rapid evaporation of the liquid and fixing of the flavoring agent onto the crust of the treated product.

The flavoring composition is as defined above.

Thus, a subject of the invention is more particularly a process for customizing the taste of bread or pastry, in which the following are applied to the crust of breads or pastries, after final baking:
a liquid flavoring composition in which the concentration of flavoring ingredient is from 5% to 50% by weight of the liquid composition, or
a pulverulent flavoring composition comprising 1% to 30% of flavoring ingredient and 70% to 99% of a support chosen from the group comprising flour, semolina, seeds such as sesame seeds, poppy seeds, cereals such as oat flakes, and mixtures thereof.

According to another particular embodiment, the bread or the pastry is prepared according to the following successive steps:

1′. Kneading

2′. Division

3′. Shaping

4′. Fermentation

5′. Optionally, prebaking

6′. Baking,

the flavoring composition being applied just after the baking step 6′.

In the embodiments described above, the processes advantageously allow:
customization of the aromatic profiles of the bakery/pastry products via the crust;
time saving by performing a single kneading operation for conversion among various recipes;
reduction of the dose used and thus of the cost of using the aromatic products.

In addition, the products with aromatic power proposed are natural, free of synthetic flavoring and therefore do not require special labeling.

The invention will be described in greater detail with the aid of the following examples, which are given for purely illustrative purposes.

### EXAMPLES

1. Preparation for Dusting of a Flavoring Composition Comprising a Support Based on Semolina Coated with a Flavoring Agent

Coating-drying is performed in a fluidized bed on an LAF Sherwood M501 machine equipped with a twin-fluid nozzle and a Masterflex peristaltic pump.

The flavoring agent is a yeast extract or a malt extract.

The first step consists in preparing the aqueous solutions comprising the flavoring agent by dissolving the latter, whether it is in powder form or liquid form. The ratio of flavoring agent/water is defined so that the solids content of the solution is between 20% and 50% and preferably between 25% and 45%.

The second step consists in spraying these yeast or malt extract solutions onto the semolina in motion in the fluidized air bed, followed by a step of drying for 10 minutes at a temperature of between 40 and 50° C.

The semolina used is a wheat semolina referenced “Durum Wheat, Dossche Mills 1000683”.

The spraying rate is 2.5 g per minute.

A semolina coated with the yeast extract sold under the reference “Springer® 0402/20-MG-L” with a degree of coating of 9% (degree of coating (%)g/100 g of product to be coated) is thus obtained.

2. Preparation of Breads and Results

An expert panel, consisting of 10 persons trained in tasting and in grading breads on a continuous grading scale (0 to 10) successively tastes and grades two groups of three products prepared according to the following baguette recipe and diagram:

| | Mass of | % on weight |
|---|---|---|
| INGREDIENTS | ingredients (g) | Flour |
| Tradition wheat flour | 1000 | 100% |
| Total fluor | 1000 | 100% |
| Water | 620 | 62.0% |
| Hirondelle Bleue pressed yeast | 20 | 2.0% |
| Salt | 18 | 1.8% |
| Ibis direct cold improver | 6 | 0.6% |
| TOTAL | 1664 | — |

| STEPS | Details |
|---|---|
| Kneading (2-speed spiral | 3 min at speed 1 + |
| dough mixer) | 5 min at speed 2 |
| Scoring | 10 min |
| Division | 350 g |
| Boiling | Medium |
| Standing | 10 min |
| Shaping | Machine |
| Finishing 28° C. | 90 min |
| Rotary oven baking | 18 min from 230° C. |
| | to 200° C. |

The following two groups of products were tested:

1/Group 1

Control Baguette

Baguette with sprayed leaven cream, dosage: about 11 to 22 mg/cm² of liquid sprayed onto the surface of each dough ball.

Baguette with leaven cream incorporated directly into the dough, dosage: 10% on weight of the flour in the dough mixer

2/Group 2

Control Baguette

Baguette flavored by dusting with a yeast extract sold under the reference “Springer® 0402/20-MG-L” (referred to hereinbelow as EXL Springer 0402), dosage: about 22 mg/cm² of a powder mixture composed of 95% of flour and 5% of Springer® 0402/20-MG-L.

Baguette with Springer® 0402/20-MG-L incorporated directly into the dough, dosage: 0.8% of pure yeast extract on weight of flour in the dough mixer

3/Group 3

Control Baguette

Baguette flavored by dusting (at a rate of 48 mg/cm²) with coated semolina obtained according to example 1 with the yeast extract sold under the reference “Springer® 0402/20-MG-L” (referred to hereinbelow as Semolina EXL Springer 0402).

The panelists tasted the products in a random order within each group, under white light, and they tested for each product a mouthful of crumb +upper crust: by smell, and then in the mouth.

They noted the following attributes:

Odor: flour, fermentation, cheese, crackers, leaven, malted-roasted.

Flavors and taste: flour, fermentation, cheese, crackers, leaven, salty, sour, malted-roasted.

The results of these tests are represented in FIGS. 1, 2 and 3 in which:

FIGS. 1a and 1b are, respectively, the diagrams obtained for the tests of group 1 with the control baguette and the baguette with sprayed leaven cream (FIG. 1a) and with the baguette with sprayed leaven cream and the baguette with leaven cream incorporated into the dough (FIG. 1b);

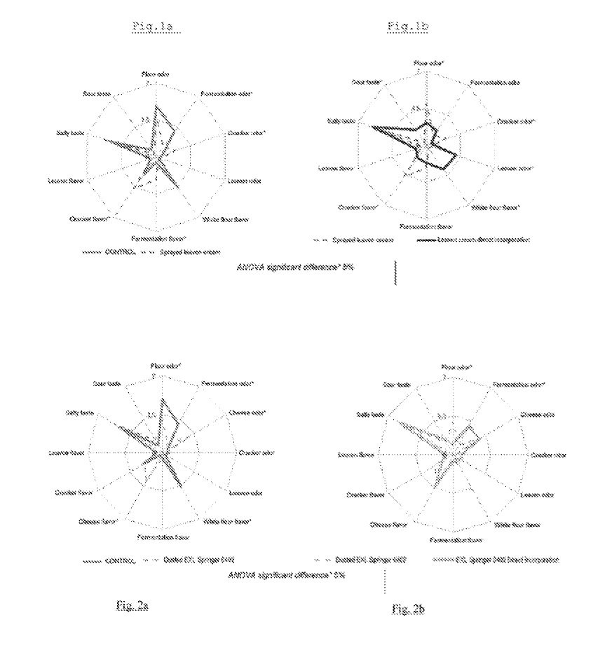

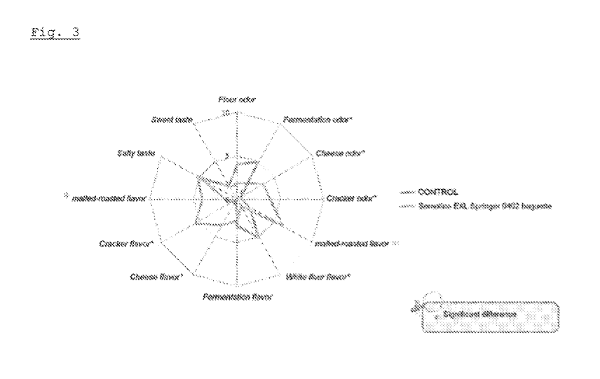

FIGS. 2a and 2b are, respectively, the diagrams obtained for the tests of group 2 with the control baguette and the baguette dusted with EXL Springer 0402 (FIG. 2a) and with the baguette dusted with EXL Springer 0402 and the baguette with EXL Springer 0402 incorporated into the dough (FIG. 2b),

FIG. 3 is the diagram obtained for the tests of group 3 with the control baguette and the baguette dusted with Semolina EXL Springer 0402 as described in point 1 (1.) of the above examples.

The main conclusions are:

Group 1

In comparison with the control and with the product with direct incorporation in the dough mixer, spraying with leaven cream gives a significantly more pronounced cracker odor and flavor, which cover the fermented odor and the white flour flavor.

The leaven note (odor and flavor) and the sour taste are not perceived on the sprayed product versus the product with direct incorporation.

Group 2

The aromatic perception of the baguette with direct incorporation of the yeast extract in the dough mixer and that of the dusted product are similar in the mouth.

The cheese odor and flavor are significantly superior to that of the control for the two products with Springer® 0402/20-MG-L.

They cover the white flour flavor perceived in the control.

Group 3

In comparison with the control, dusting of the baguette with a semolina flavored with the yeast extract Springer 0402 gives a significantly more pronounced cracker, malted-roasted and cheese odor and flavor. This covers the fermented odor and the white flour flavor of a control baguette without aromatic dusting.

1. A process for customizing the taste of bread or pastry, wherein the following are applied to the surface of the shaped dough ball or to the crust of the bread or pastry, before final baking:
a liquid flavoring composition in which the concentration of flavoring ingredient is from 5% to 50% by weight of the liquid composition, or
a pulverulent flavoring composition comprising 1% to 30% of flavoring ingredient and 70% to 99% of a support chosen from the group comprising flour, semolina, seeds such as sesame seeds, poppy seeds, cereals such as oat flakes, and mixtures thereof.

2. The process as claimed in claim 1, wherein the flavoring composition comprises as flavoring or taste-providing ingredient: malt, a malt extract, a yeast derivative, a dry or liquid leaven or any mixture of these ingredients.

3. The process as claimed in claim 1, wherein the flavoring ingredient is placed in a liquid medium or in the browning, preferably water, or is mixed with a support as defined in claim 1.

4. The process as claimed in claim 1, wherein the flavoring composition is liquid and is applied by spraying.

5. The process as claimed in claim 4, wherein the liquid composition is applied by spraying at a rate of from 4 to 40 mg of liquid composition per cm2 of surface.

6. The process as claimed in claim 1, wherein the composition is pulverulent and is applied by dusting.

7. The process as claimed in claim 6, wherein the pulverulent composition is applied by dusting at a rate of from 4 to 100 mg per cm2 of surface.

8. The process as claimed in claim 1, wherein it comprises the following successive steps:
1. Kneading
2. Division
3. Shaping
4. Fermentation
5. Baking,
the flavoring composition being applied just before the baking step 5.

9. The process as claimed in claim 8, wherein it comprises the following successive steps:
1′. Kneading
2′. Division
3′. Shaping
4′. Fermentation
5′. Prebaking
6′. Baking,
the flavoring composition being applied either just before the prebaking step 5′ or just before the baking step 6′.
